(19) United States
(12) Patent Application Publication
(10) Pub. No.: US 2009/0035559 A1
(43) Pub. Date: Feb. 5, 2009

(54) Material for forming electroless plate and method for producing electrolessly plated non-conductive substrate

(75) Inventors: Keiko Kitamura, Saitama-shi (JP); Takashi Shimizu, Saitima-shi (JP); Tetsuji Ohta, Saitama-shi (JP); Masayuki Nakatani, Saitama-shi (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., Tokyo (JP)

(21) Appl. No.: 12/153,207

(22) Filed: May 15, 2008

(30) Foreign Application Priority Data
May 17, 2007 (JP) 2007-131385
May 17, 2007 (JP) 2007-131386

(51) Int. Cl. B32B 5/00; B05D 3/10; H05H 1/24

(52) U.S. Cl. 428/336; 427/304; 427/302; 427/535

(57) ABSTRACT

A material for forming electroless plate comprising a non-conductive substrate and a catalyst adhering layer provided on the substrate is constituted so that the catalyst adhering layer contains a hydrophilic ionizing radiation curable resin composition, a surface of the catalyst adhering layer shows a contact angle of 60° or smaller to purified water, and preferably the hydrophilic ionizing radiation curable resin composition is in a half-cured state for the portion of the catalyst adhering layer. A material for forming electroless plate shows favorable adhesion for catalyst, and the catalyst adhering layer hardly dissolves into a plating solution in the step of adhering catalyst, the step of development and other steps.

### TECHNICAL FIELD

The present invention relates to a material for forming electroless plate formed by subjecting a non-conductive substrate to a treatment enabling electroless plating, and a method for producing an electrolessly plated non-conductive substrate.

### BACKGROUND ART

Electroless plating is widely used as an industrial technique which can change non-conductive substrate surfaces such as those of plastics, ceramics, paper, glass, and fibers into conductive surfaces. Especially when a surface of non-conductive substrate is electrolytically plated, the non-conductive substrate is electrolessly plated as a pretreatment for the electrolytic plating.

In order to electrolessly plating a non-conductive substrate, it is indispensable to form a layer of fine metal particles having a catalytic activity (catalyst layer) on the non-conductive substrate surface as a pretreatment. However, since surfaces of non-conductive substrates are generally smooth, it is difficult to directly adhere a catalyst layer to them. When performances of transparence, light weight, high hardness and so forth are required for non-conductive substrates, ionizing radiation curable resins are frequently used for them. However, ionizing radiation curable resins generally are not sufficiently hydrophilic, and surface absorptivity thereof is further degraded by crosslinking. Therefore, it is especially difficult to adhere a catalyst by adsorption of a colloidal solution of the catalyst.

As a method for facilitating adhesion of catalyst to surfaces of non-conductive substrates, there are methods of roughening surfaces of non-conductive substrates by a mechanical treatment or a chemical treatment. However, if substrate surfaces are roughened, the substrates become opaque as a whole, and thus they have a problem that the substrates become unsuitable for use that requires transparency.

As means for solving this problem, there have been proposed a method of forming a gelatinous thin membrane (catalyst adhering layer) containing a water-soluble polymer on a non-conductive substrate, a method of forming a photo-curable primer layer and subjecting the layer to a pretreatment of immersing it in a strongly alkaline aqueous solution, and so forth (Patent documents 1 and 2).

Patent document 1: Japanese Patent Unexamined Publication (KOKAI) No. 2002-220677 (claims)
Patent document 2: Japanese Patent Unexamined Publication (KOKAI) No. 10-317153 (claims)

### DISCLOSURE OF THE INVENTION

### Object to be Achieved by the Invention

However, in the method of Patent document 1, although the gelatinous thin membrane adheres the catalyst, the gelatinous thin membrane may be delaminated from the non-conductive substrate or dissolved when the substrate is immersed in a catalyst bath in the catalyst adhering step, or when a developer is brought into contact with gelatinous thin membrane in a development step after electrolytic plating. Further, the method of Patent document 2 requires a treatment with a sufficiently strong alkali for hydrolysis of the photo-curable primer layer as a pretreatment of adhesion of catalyst.

Therefore, an object of the present invention is to provide a material for forming electroless plate showing favorable adhesion for catalyst and not showing delamination of a catalyst adhering layer from a non-conductive substrate or dissolution of the same into a plating solution in the step of adhering catalyst, the step of development and other steps.

Another object of the present invention is to provide a method enabling reliable electroless plating on a non-conductive substrate at least of which surface is formed from an ionizing radiation curable resin composition with fewer steps.

### Means for Achieving the Object

The material for forming electroless plate of the present invention, which can achieve the aforementioned object, comprises a non-conductive substrate and a catalyst adhering layer provided on the substrate, and is characterized in that the catalyst adhering layer contains a hydrophilic ionizing radiation curable resin composition, and a surface of the catalyst adhering layer shows a contact angle of 60° or smaller to purified water.

Moreover, the method for producing an electrolessly plated non-conductive substrate of the present invention comprises the steps of forming at least surface of a non-conductive member with a hydrophilic ionizing radiation curable resin composition, adjusting contact angle of the surface to purified water to be 60° or smaller, adhering a catalyst to the surface while the hydrophilic ionizing radiation curable resin composition is in an uncured or half-cured state, advancing curing of the hydrophilic ionizing radiation curable resin composition, and then performing electroless plating.

### EFFECT OF THE INVENTION

Since the catalyst adhering layer of the material for forming electroless plate of the present invention comprises a hydrophilic ionizing radiation curable resin composition and adjusted so that the surface thereof should show a contact angle of 60° or smaller to purified water, it shows favorable catalyst adhesion performance, and the catalyst adhering layer does not dissolve in a plating solution. In particular, by maintaining the ionizing radiation curable resin composition to be in a half-cured state before adhesion of the catalyst, it shows well-balanced adhesion for catalyst and dissolution preventing property.

Moreover, according to the method for producing an electrolessly plated non-conductive substrate of the present invention, since the non-conductive substrate surface has extremely favorable adhesion for catalyst, an electroless plate can be easily formed on the non-conductive substrate in a short period of time, and the catalyst adhering layer on the non-conductive substrate or the ionizing radiation curable resin composition does not dissolve during the operation. Further, since the ionizing radiation curable resin composition has cured at the time of the electroless plating, dissolution thereof into a plating solution can be prevented also in the subsequent plating process.

Especially when at least a part of the non-conductive substrate is formed from an ionizing radiation curable resin composition, by using a hydrophilic ionizing radiation curable resin composition adjusted so that the surface thereof should show a contact angle to purified water of 60° or smaller as the resin composition forming the non-conductive substrate itself, it becomes unnecessary to separately form a layer for adhering a catalyst, and therefore electroless plating can be performed with fewer steps.

### BEST MODE FOR CARRYING OUT THE INVENTION

Hereafter, embodiments of the material for forming electroless plate of the present invention will be explained.

Examples of the non-conductive substrate include plastic films such as those of polyester, ABS (acrylonitrile/butadiene/styrene rubber), polystyrene, polycarbonate, acrylic resin, liquid crystal polymer (LCP), polyolefin, cellulose resin, polysulfone, polyphenylene sulfide, polyethersulfone, polyetheretherketone and polyimide, glass plates, ceramic plates, paper sheets, fibers, and so forth. Among these, transparent substrates such as those consisting of plastics and glass can be preferably used from the viewpoint that they allow favorable observation of metallic luster from the non-conductive substrate side after the plate formation. The non-conductive substrate is not limited to those having a flat shape, and it may have a three-dimensional shape.

The non-conductive substrate may be one subjected to an adhesion promoting treatment for enhancing adhesion to the catalyst adhering layer. Examples of the adhesion promoting treatment include corona discharge treatments, plasma treatments, undercoating treatments, and so forth.

When the non-conductive substrate may be opaque, a substrate having a roughened surface may also be used. If the surface of the substrate is roughened, the surface of the catalyst adhering layer can be roughened by the surface roughness of the substrate, and adhesion of the catalyst can be made easier.

The catalyst adhering layer plays a role of adhering fine metal particles having a catalytic activity for electroless plating (catalyst). In the present invention, a catalyst adhering layer containing a hydrophilic ionizing radiation curable resin composition is used as the catalyst adhering layer.

As the ionizing radiation curable resin composition, a photo-cationic porimerizable resin that can cause photo-cationic polymerization and can be cured through crosslinking by irradiation of ionizing radiation (ultraviolet ray or electron beam) can be used.

As such a photo-cationic porimerizable resin, epoxy type resins such as bisphenol type epoxy resin, novolak type epoxy resins, alicyclic epoxy resins and aliphatic epoxy resin, vinyl ether type resins and so forth, which are formed by introducing a hydrophilic base structure or functional groups, can be used.

As the ionizing radiation curable resin composition, photopolymerizable prepolymers that can cause photo radical polymerization and can be cured through crosslinking by irradiation of ionizing radiation (ultraviolet ray or electron beam) can be used.

As such photopolymerizable prepolymers that can cause photo radical polymerization, acrylic type prepolymers that have two or more acryloyl groups in the molecule and form a three-dimensionally reticular structure through crosslinking curing are particularly preferably used. Although these acrylic type prepolymers may be independently used, it is preferable to add photopolymerizable monomers in order to impart various performances such as improvement in crosslinking curing property and adjustment of shrinkage upon curing. Used as the photopolymerizable monomers are one or more kinds of monofuctional acrylic monomers such as 2-ethylhexyl acrylate, 2-hydroxyethyl acrylate, 2-hydroxypropyl acrylate and butoxyethyl acrylate, bifuctional acrylic monomers such as 1,6-hexanediol diacrylate, neopentyl glycol diacrylate, diethylene glycol diacrylate, polyethylene glycol diacrylate, hydroxypivalic acid ester neopentyl glycol diacrylate and ethoxylated bisphenol A diacrylate, polyfuctional acrylic monomers such as dipentaerythritol hexaacrylate, trimethylpropane triacrylate and pentaerythritol triacrylate, and so forth.

When photopolymerizable prepolymers that can cause radical polymerization are used as the ionizing radiation curable resin composition, the photopolymerizable prepolymers and/or the photopolymerizable monomers should be formed by introducing a hydrophilic base structure or functional groups.

Examples of the hydrophilic base structure which is introduced into the photo cationic polymerizable resin, the photopolymerizable prepolymers or the photopolymerizable monomers mentioned above include ethylene oxide and so forth, and examples of the hydrophilic functional groups include hydroxyl group, carboxylic acid group, and so forth.

Further, to the ionizing radiation curable resin composition, additives such as photopolymerization initiator, photopolymerization enhancer, ultraviolet radiation sensitizing agent and pigment can be added.

Example of the photopolymerization initiator include cationic polymerization photoinitiators such as onium salts, sulfonic acid esters and organometallic complexes, and radical polymerization photoinitiators such as acetophenone, benzophenone, Michler's ketone, benzoin, benzyl methyl ketal, benzoyl benzoate, α-acyl oxime esters and thioxanthones. Examples of the photopolymerization enhancer include p-dimethylaminobenzoic acid isoamyl ester, p-dimethylaminobenzoic acid ethyl ester and so forth.

Examples of the ultraviolet radiation sensitizing agent include n-butylamine, triethylamine, tri-n-butylphosphine and so forth.

The catalyst adhering layer may contain a resin other than the hydrophilic ionizing radiation curable resin composition mentioned above. Examples of such a resin include, for example, polyvinylbutyral type resins, (meth)acrylic type resins, polyester type resins, polyurethane type resins and so forth. Although the resin other than the hydrophilic ionizing radiation curable resin composition mentioned above may be hydrophilic or hydrophobic, it is preferably water-insoluble in order to prevent dissolution. Even when the other resin is added, the hydrophilic ionizing radiation curable resin composition mentioned above is preferably contained in an amount of 50% by weight or more, more preferably 80% by weight or more, still more preferably 90% by weight or more, based on the total weight of the resins constituting the catalyst adhering layer.

First, in order to form the catalyst adhering layer on the non-conductive substrate, a coating solution dissolving materials constituting the layer such as the resins in an appropriate solvent is applied on the non-conductive substrate by a known coating method such as bar coating and dried, or materials constituting the non-conductive substrate and materials constituting the catalyst adhering layer are co-extruded to form the layers. The catalyst adhering layer does not need to be formed over the whole surface of the non-conductive substrate, and it may be formed over a part of it. By providing the catalyst adhering layer over a pert of the non-conductive substrate, the catalyst can be selectively adhered to the part of the non-conductive substrate, and thus the electroless plating and electrolytic plating can be selectively performed on the part.

The catalyst adhering layer preferably has a thickness of 0.1 to 5 μm. A thickness of 0.1 μm or larger makes adhesion of the catalyst easier, and a thickness of 5 μm or smaller prevents delamination of the catalyst adhering layer due to invasion of a developer from the sides at the time of the pattern formation mentioned later, and prevents degradation of insulating characteristics.

Then, the contact angle of the surface of the catalyst adhering layer to purified water is adjusted to be 60° or smaller, preferably 500 or smaller. As the method for adjusting the contact angle, there are (1) a method of controlling conditions of irradiation of ionizing radiation to control the curing, (2) a method of subjecting the coated surface of the catalyst adhering layer to a corona discharge treatment, and so forth, and any method may be employed. A corona discharge treatment is preferred from the viewpoint that the control is easy and the contact angle can surely be made to be 60° or smaller.

When the conditions of ionizing radiation irradiation are adjusted, curing state (uncured, half-cured, completely cured) is controlled depending on the characteristics of the hydrophilic ionizing radiation curable resin composition. For example, when the ionizing radiation curable resin composition is one which does not lose hydrophilicity even after it cures, the contact angle can be made to be 60° or smaller even if curing considerably advances. On the other hand, when the ionizing radiation curable resin composition is one which loses hydrophilicity after it cures, it is maintained to be in an uncured or half-cured state, and further cured after adhesion of the catalyst.

As a preferred embodiment of the control of curing state, the ionizing radiation curable resin composition is maintained to be in a half-cured state before the adhesion of the catalyst irrespective of the presence or absence of hydrophilicity after curing of the ionizing radiation curable resin composition, and the resin composition is further cured after the adhesion of the catalyst. By controlling as described above, the contact angle can be adjusted to be 60° or smaller, sufficient catalyst adhesion can be obtained, and since the catalyst adhering layer is appropriately cured before the adhesion step, dissolution of it into a catalyst bath can be prevented. Moreover, by further curing the resin composition in the electroless plating step, the property for preventing dissolution into a plating solution can be made sufficient.

The curing state of the ionizing radiation curable resin composition can be controlled by adjusting the dose of ionizing radiation. For example, to obtain a half-cured state, irradiation is performed at a dose corresponding to 70% or less, preferably 50% or less, of a dose required for complete curing by irradiation of ionizing radiation. The dose of ionizing radiation can be suitably adjusted depending on types of the resin and photopolymerization initiator to be used, thickness of the catalyst adhering layer, wavelength of the ionizing radiation to be irradiated, and so forth.

Irradiation of ionizing radiation can be performed by irradiation of ultraviolet rays having a wavelength in the range of 100 to 400 nm, preferably 200 to 400 nm, from an ultra-high pressure mercury lamp, a high pressure mercury lamp, a low pressure mercury lamp, carbon arc, a metal halide lamp or the like, or by irradiation of electron beams having a wavelength in the range of 100 nm or smaller from a scanning type or curtain type electron beam accelerator.

When the contact angle of the surface of the catalyst adhering layer to purified water is adjusted by a corona discharge treatment, the catalyst adhering layer may be in an uncured state, half-cured state or sufficiently cured state. The adjustment is preferably performed for the catalyst adhering layer in a state that the layer is cured to a certain extent.

The corona discharge treatment is performed by applying a high frequency and high voltage current between a discharge electrode and a counter electrode to induce corona discharge and exposing the non-conductive substrate on which the catalyst adhering layer is formed to the corona discharge for a predetermined time. Corona discharge treatment apparatuses are classified into those of batch type and web conveyance type according to the shape of the counter electrode, and a corona discharge treatment apparatus suitable for the shape of non-conductive substrate is used. Electric power for the treatment is usually 0.1 to 5.0 kW. By adjusting the electric power for the treatment and/or treatment time, the contact angle can be adjusted to be 60° or smaller.

Hereafter, the method for producing an electrolessly plated non-conductive substrate of the present invention will be explained. The non-conductive substrate as an object of the method of the present invention is (1) a material for forming electroless plate comprising a non-conductive substrate and a catalyst adhering layer provided on the substrate (the material for forming electroless plate of the present invention mentioned above), or (2) a non-conductive substrate at least of which surface is formed with a hydrophilic ionizing radiation curable resin composition. As for the non-conductive substrate of the latter (2), it may be formed with a hydrophilic ionizing radiation curable resin composition as a whole, or a part of it including the surface may be formed with a hydrophilic ionizing radiation curable resin composition. However, the portion of the ionizing radiation curable resin composition preferably has a thickness of 0.1 μm or larger. With a thickness of 0.1 μm or larger, it can be made easier to adhere the catalyst.

As the ionizing radiation curable resin composition of the substrate of the latter (2), the same materials as those explained for the catalyst adhering layer of the former (1) can be used, and contact angle to purified water of the surface thereof should be adjusted to be 60° or smaller like the catalyst adhering layer. Since specific materials of the catalyst adhering layer and the method for adjusting the contact angle are explained above, explanation for them are omitted here. Hereafter, the both are collectively referred to as the non-conductive substrate.

The method of the present invention is characterized by adhering a catalyst to the surface of the non-conductive substrate of which contact angle to purified water is adjusted to be 60° or smaller, then curing the hydrophilic ionizing radiation curable resin composition, and then performing electroless plating. Each step will be explained below.

First, a catalyst is adhered to the surface of the non-conductive substrate mentioned above. The catalyst is preferably adhered while the ionizing radiation curable resin composition is still maintained to be in an uncured state.

As the fine metal particles having a catalytic activity for electroless plating (catalyst), those of gold, silver, ruthenium, rhodium, palladium, tin, iridium, osmium, platinum and so forth and mixtures thereof can be used. The catalyst is preferably used as a colloidal solution. Generally used as the method for the preparation of a colloidal solution of the catalyst is a method of dissolving a water-soluble salt containing the catalyst in water, adding a surfactant to the solution, and adding a reducing agent to the mixture with vigorous stirring. However, other known methods may also be used.

Examples of the method for adhering the catalyst to the surface of the non-conductive substrate include a method of successively performing a sensitization treatment (sensitizing) and an activation treatment (activating), and a method of successively performing catalyzing and accelerating. Since the surface of the non-conductive substrate used in the method of the present invention is formed from the ionizing radiation curable resin composition showing a specific surface property (contact angle), the catalyst adhesion step can be completed in an extremely short period of time, and thereby dissolution of a portion of the ionizing radiation curable resin composition (catalyst adhering layer) into the catalyst solution can be prevented. Further, a pattern of the catalyst in a desired shape can also be formed by using an ink-jet printer in which the colloidal solution of the catalyst is filled in an ink tank.

In addition, it is preferable to perform a degreasing treatment of the non-conductive substrate by washing with an acid and/or alkali before the catalyst is adhered to the surface of the non-conductive substrate. Since the surface of the non-conductive substrate used in the method of the present invention is formed from the ionizing radiation curable resin composition having the specific surface property (contact angle), the degreasing treatment can also be completed in an extremely short period of time.

Moreover, conditioning and pre-dipping steps are generally performed before a catalyst is adhered to a catalyst adhering layer in addition to the degreasing treatment in the conventional techniques. However, since the surface of the non-conductive substrate used in the method of the present invention is formed from the ionizing radiation curable resin composition having the specific surface property (contact angle), those steps may be omitted.

When the ionizing radiation curable resin composition of the surface of the non-conductive substrate or the catalyst adhering layer is used in an uncured or half-cured state, it is preferable to further cure the ionizing radiation curable resin composition after the adhesion of the catalyst and before the electroless plating in order to prevent dissolution of the ionizing radiation curable resin composition into a plating bath. Irradiation of ionizing radiation can be performed by irradiation of ultraviolet rays having a wavelength in the range of 100 to 400 nm, preferably 200 to 400 nm, from an ultra-high pressure mercury lamp, a high pressure mercury lamp, a low pressure mercury lamp, carbon arc, a metal halide lamp or the like, or by irradiation of electron beams having a wavelength in the range of 100 nm or smaller from a scanning type or curtain type electron beam accelerator.

After the catalyst is adhered to the surface of the non-conductive substrate, electroless plating is performed.

The electroless plating can be performed by, for example, immersing the material for forming electroless plate on which the catalyst is adhered in an electroless plating bath containing a water-soluble compound of a metal to be plated (usually metal salt), a complexing agent, a pH adjustor, a reducing agent and a plating aid. By adjusting various conditions such as bath composition, temperature, pH and immersion time, thickness of the electroless plate can be controlled.

Examples of the metal to be plated by the electroless plating including non-electrolytic copper, non-electrolytic nickel, non-electrolytic copper/nickel/phosphorus alloy, non-electrolytic nickel/phosphorus alloy, non-electrolytic nickel/boron alloy, non-electrolytic cobalt/phosphorus alloy, non-electrolytic gold, non-electrolytic silver, non-electrolytic palladium, non-electrolytic tin and so forth.

As the complexing agent, pH adjustor, plating aid and reducing agent, those conventionally known as these can be used.

After an electroless plate is formed, electrolytic plating is performed as required. The electrolytic plating can be performed by immersing the non-conductive substrate on which electroless plate is formed in a known electrolytic plating bath and electrifying it. By adjusting current density and electrification time, thickness of the electrolytic plate can be adjusted.

After the electrolytic plate is formed, pattern formation may be performed as required. The pattern formation can be performed by, for example, applying a photoresist to the electrolytic plate, performing exposure and removing the photoresist of exposed or unexposed portions with a developer together with the electrolytic plate, the electroless plate and the catalyst adhering layer.

The non-conductive substrate on which electroless plate or electroless plate and electrolytic plate are formed as described above can be used for a printed wiring board, an electromagnetic wave shielding member, a sheet type heating element, an antistatic sheet, an antenna, an antiglare sheet, an ornament and so forth.

### EXAMPLES

Hereafter, the present invention will be further explained with reference to examples. The term “part” and the symbol “%” are used on the weight basis, unless specifically indicated.

### Example 1

On one surface of a polyester film having a thickness of 125 μm (COSMOSHINE A4300, Toyobo Co., Ltd.), a coating solution for catalyst adhering layer (a) having the following composition was applied so as to have a dry thickness of 3 μm with a bar coater, dried and then irradiated with an ultraviolet ray from a high pressure mercury lamp (dose: 50 mJ/cm²) to obtain a material for forming electroless plate of Example 1.

<Coating solution for catalyst adhering layer (a)>

| | | |
|---|---|---|
| Ionizing radiation curable resin composition | 10 | parts |
| (Beam Set 575, Arakawa Chemical Industries, Ltd., | | |
| solid content: 100%) | | |
| Polyethylene glycol diacrylate | 5 | parts |
| (NK Ester A-1000, Shin-Nakamura Chemical Co., Ltd., | | |
| Solid content: 100%) | | |
| Photopolymerization initiator | 0.5 | part |
| (Irgacure 651, Ciba Speciality Chemicals Inc.) | | |
| Propylene glycol methyl ether | 23 | parts |

### Example 2

A material for forming electroless plate of Example 2 was obtained in the same manner as that of Example 1 except that the dose of ultraviolet ray was changed to 400 mJ/cm² and the surface of the catalyst adhering layer was subjected to a corona discharge treatment (discharger of 1.4 kW was used, and the material was treated twice at a flow rate of 20 m/minute) after the ultraviolet ray irradiation.

### Example 3

A material for forming electroless plate of Example 3 was obtained by further subjecting the surface of the catalyst adhering layer of the material for forming electroless plate of Example 2 to a corona discharge treatment (a discharger of 1.4 kW was used, and the material was treated twice at a flow rate of 20 m/minute).

### Example 4

A material for forming electroless plate of Example 4 was obtained in the same manner as that of Example 1 except that the solution for catalyst adhering layer (a) was changed to the coating solution for catalyst adhering layer (b) having the following composition.

<Coating solution for catalyst adhering layer (b)>

| | |
|---|---|
| Epoxy acrylate (Denacol DA-911M, Nagase ChemteX | 8 parts |
| Corporation) | |
| Polyethylene glycol diacrylate | 4 parts |
| (NK Ester A-1000, Shin-Nakamura Chemical Co., Ltd., | |
| Solid content: 100%) | |
| Pentaerythritol triacrylate | 4 parts |
| Photopolymerization initiator | 1 part |
| (Irgacure 184, Ciba Speciality Chemicals Inc.) | |

### Comparative Example 1

A material for forming electroless plate of Comparative Example 1 was obtained in the same manner as that of Example 1 except that the dose of ultraviolet ray was changed to 400 mJ/cm².

### Comparative Example 2

A material for forming electroless plate of Comparative Example 2 was obtained in the same manner as that of Example 1 except that 0.02 part of a surface regulator (BYK355, BYK Chemie GmbH) was added to the coating solution for catalyst adhering layer (b) and the dose of ultraviolet ray was changed to 400 mJ/cm².

### Comparative Example 3

A material for forming electroless plate of Comparative Example 3 was obtained by subjecting a polyester film having a thickness of 100 μm (Lumirror T60, Toray Industries, Inc.) to a corona discharge treatment (discharger of 1.4 kW was used, and the material was treated twice at a flow rate of 20 m/minute).

### Comparative Example 4

On one surface of a polyester film having a thickness of 100 μm (Lumirror T60, Toray Industries, Inc.), a coating solution for catalyst adhering layer obtained by diluting a water-soluble polyester resin (Pesresin A-110, Takamatsu Oil & Fat Co., Ltd.) with a solvent was applied so as to have a dry thickness of 3 μm and dried to obtain a material for forming electroless plate of Comparative Example 4.

Subsequently, the following step (1) to (4) were performed for the materials for forming electroless plate obtained in Examples 1 to 4 and Comparative Examples 1 to 4 to form an electroless plate and an electrolytic plate on a surface of each material for forming electroless plate. As for the materials for forming electroless plate of Examples 1 and 4, an ultraviolet ray was irradiated at 350 mJ/cm² between the catalyst adhering step (2) and the electroless plating step (3) to further cure the catalyst adhering layer.

### (1) Degreasing Treatment

A degreasing treatment was performed for 60 seconds by using an aqueous alkaline solution.

### (2) Catalyst Adhesion

Sensitization and activation were successively performed for 180 seconds and 30 seconds, respectively, by using a colloidal solution of a mixture of palladium and tin as a catalyst bath.

### (3) Electroless Plating

Electroless plating was performed by using an electroless plating bath having the following composition under the conditions of a bath temperature of 60° C. and an immersion time of 15 minutes.

<Electroless plating bath>

| | | |
|---|---|---|
| Copper sulfate pentahydrate | 0.03 | M |
| EDTA tetrahydrate | 0.24 | M |
| Formalin | 0.20 | M |
| Dipyridyl | 10 | ppm |
| Surfactant | 100 | ppm |

### (4) Electrolytic Plating

Electrolytic plating was performed by using a copper sulfate plating bath (CU-BRITE TH Process, Ebara-Udylite Co., Ltd.) as an electrolytic plating bath until the plate thickness became about 30 μm.

The materials for forming electroless plate of Examples 1 to 4 and Comparative Examples 1 to 4 on which electroless plate and electrolytic plate were formed were evaluated for the following items. The results are shown in Table 1. Moreover, the contact angles to purified water of the catalyst adhering layer surfaces of the materials for forming electroless plate of Examples 1 to 4 and Comparative Examples 1 to 4 are also shown in Table 1.

### (1) Uniformity of Plate

Whether the plate was uniformly formed or not was evaluated by visual inspection. Plate uniformly formed without unevenness is indicated with “0”, and plate not uniformly formed with unevenness is indicated with “X”.

### (2) Dissolution Preventing Property

Each material was immersed in purified water for 10 minutes, took out, and sufficiently dried, and the weight change relative to the weight before the immersion was measured. Results of no dissolution and no weight change are indicated with “◯”, and results of dissolution of 20% by weight or more of the catalyst adhering layer are indicated with “×”.

TABLE 1

| | | | Dissolution |
|---|---|---|---|
| | Contact | | preventing |
| | angle | Uniformity | property |
| Example 1 | 60° | ◯ | ◯ |
| Example 2 | 60° | ◯ | ◯ |
| Example 3 | 45° | ◯ | ◯ |
| Example 4 | 50° | ◯ | ◯ |
| Comparative Example 1 | 80° | X | ◯ |
| Comparative Example 2 | 75° | X | ◯ |
| Comparative Example 3 | 20° | X | ◯ |
| Comparative Example 4 | 40° | ◯ | X |

Since the catalyst adhering layers of the materials for forming electroless plate of Examples 1 to 4 contained the ionizing radiation curable resin composition and the surfaces thereof showed a contact angle to purified water of 60° or smaller, the materials showed superior uniformity and dissolution preventing property. Moreover, since the step of further curing the catalyst adhering layer was performed after the adhesion of the catalyst in Examples 1 and 4, the materials of these examples showed extremely superior balance of catalyst adhesion and dissolution preventing property.

Since the surfaces of the catalyst adhering layers of the materials for forming electroless plate of Comparative Examples 1 and 2 showed a contact angle to purified water larger than 60°, the materials showed inferior uniformity due to bad adhesion of the catalyst, although they had a catalyst adhering layer containing an ionizing radiation curable resin.

Since the material for forming electroless plate of Comparative Example 3 did not have the catalyst adhering layer, it showed bad uniformity, although the surface of it showed a contact angle to purified water of 60° or smaller.

Since the resin contained in the catalyst adhering layer of the material for forming electroless plate of Comparative Example 4 was a water-soluble resin, the material showed poor dissolution preventing property, although the catalyst adhering layer showed a small contact angle.

1. A material for forming electroless plate comprising a non-conductive substrate and a catalyst adhering layer provided on the substrate,
wherein the catalyst adhering layer contains a hydrophilic ionizing radiation curable resin composition, and a surface of the catalyst adhering layer shows a contact angle of 60° or smaller to purified water.

2. The material for forming electroless plate according to claim 1,
wherein the catalyst adhering layer has a thickness of 0.1 to 5 μm.

3. The material for forming electroless plate according to claim 1,
wherein at least a surface of the non-conductive substrate on which the catalyst adhering layer is formed with the ionizing radiation curable resin composition.

4. A method for producing an electrolessly plated non-conductive substrate, which comprises adhering a catalyst to the catalyst adhering layer of the material for forming electroless plate according to claim 3, and then performing electroless plating.

5. A method for producing an electrolessly plated non-conductive member, which comprises:
forming at least surface of a non-conductive member with a hydrophilic ionizing radiation curable resin composition, adjusting contact angle of the surface to purified water to be 60° or smaller,
adhering a catalyst to the surface while the hydrophilic ionizing radiation curable resin composition is in an uncured or half-cured state,
advancing curing of the hydrophilic ionizing radiation curable resin composition, and
then performing electroless plating.

6. The method for producing an electrolessly plated non-conductive member according to claim 5,
wherein the surface of the non-conductive member formed from the hydrophilic ionizing radiation curable resin composition is subjected to a corona discharge treatment to adjust contact angle of the surface to purified water to be 60° or smaller.

7. The method for producing an electrolessly plated non-conductive member according to claim 6,
wherein the non-conductive member is formed from the ionizing radiation curable resin composition as a whole.

8. The material for forming electroless plate according to claim 2,
wherein at least a surface of the non-conductive substrate on which the catalyst adhering layer is formed with the ionizing radiation curable resin composition.

9. A method for producing an electrolessly plated non-conductive substrate, which comprises adhering a catalyst to the catalyst adhering layer of the material for forming electroless plate according to claim 1, and then performing electroless plating.

10. The method for producing an electrolessly plated non-conductive member according to claim 5,
wherein the non-conductive member is formed from the ionizing radiation curable resin composition as a whole.

11. A method for producing an electrolessly plated non-conductive substrate, which comprises adhering a catalyst to the catalyst adhering layer of the material for forming electroless plate according to claim 2, and then performing electroless plating.
